(19) United States
(12) Patent Application Publication
(10) Pub. No.: US 2004/0064396 A1
(43) Pub. Date: Apr. 1, 2004

(54) One-to-one method of exchanging goods

(76) Inventor: Mustafa Erhan Say, Istanbul (TR)

Correspondence Address: DAVIDSON, DAVIDSON & KAPPEL, LLC, 485 SEVENTH AVENUE, 14TH FLOOR, NEW YORK, NY, 10018, US

(21) Appl. No.: 10/256,307

(22) Filed: Sep. 27, 2002

(51) Int. Cl. G06F 17/60

(52) U.S. Cl. 705/37

(57) ABSTRACT

A computerized method for exchanging products or services is provided. A first entity referred to as marketmaker specifies one or more terms for a product. The terms comprise product name, grade, quantity range, product's origin (whether it is subject to customs duty or not), delivery point, payment term and a price. One or more offers to sell a product are received from a seller. The offer to sell comprises of the following terms: Product Name, grade, product specifications, origin, producer, quantity, delivery point, delivery period, payment term, invited parties, limitations for buyer counters and price. If the price of any particular sell offer is higher than the price specified by the marketmaker for that particular offer, the offer is rejected and cannot be posted on the Exchange. In response to the offer to sell, one or more counter offers to buy from one or more buyers for the product are received. The price of any counter offer to buy from one or more buyers is rejected by the system if the buyer's price is lower than the price specified by the seller under “limitations for buyer counters”. The limitation can be set so that the seller may be open to counter offers only within 1, 2 or 3 percent of his/her original posted price. An acceptance of at least one of the counter buy offers or a revised offer to sell are received from the seller. At least one acceptance of the revised offer to sell, or a revised counter offer to buy are received from the buyer. The steps of rejecting and accepting are repeated until the Exchange closes with the revised offer to sell now the offer to sell and the revised offer to buy now the offer to buy.

### FIELD OF THE INVENTION

The present invention relates to a method of buying and selling goods. Specifically, the present invention relates to buying and selling goods in an auction Transaction

### BACKGROUND INFORMATION

The Internet, a network connecting many computer networks and based on a common addressing system and communications protocol called TCP/IP (Transmission Control Protocol/Internet Protocol), has revolutionized the computer and communications world like nothing before. From its creation in 1983 it grew rapidly beyond its largely academic origin into an increasingly commercial and popular medium.

By the mid-1990s the Internet connected millions of computers throughout the world. Many commercial computer network and data services also provided at least indirect connection to the Internet

The original uses of the Internet were electronic mail (commonly called “Email”), file transfer (using ftp, or file transfer protocol), bulletin boards and newsgroups, and remote computer access (telnet). The World Wide Web, which enables simple and intuitive navigation of Internet sites through a graphical interface, expanded dramatically during the 1990s to become the most important component of the Internet.

The Internet had its origin in a U.S. Department of Defense program called ARPANET Advanced Research Projects Agency Network), established in 1969 to provide a secure and survivable communications network for organizations engaged in defense-related research. Researchers and academics in other fields began to make use of the network, and at length the National Science Foundation (NSF), which had created a similar and parallel network called NSFNet, took over much of the TCP/IP technology from ARPANET and established a distributed network of networks capable of handling far greater traffic. NSF continues to maintain the backbone of the network (which carries data at a rate of 45 million bits per second), but Internet protocol development is governed by the Internet Architecture Board, and the InterNIC (Internet Network Information Center) administers the naming of computers and networks.

Amateur radio, cable television wires, spread spectrum radio, satellite, and fibre optics all have been used to deliver Internet services. Networked games, networked monetary transactions, and virtual museums are among applications being developed that both extend the network's utility and test the limits of its technology.

In recent years, it has also become increasingly common to have auctions over the Internet, with the buyer using credit cards or other forms of credit to purchase the goods auctioned.

### SUMMARY OF THE INVENTION

A computerized method for exchanging products or services is provided. A first entity, which is referred to as marketmaker, specifies one or more terms for a product. The terms comprise product name, grade, quantity range, product's origin (whether it is subject to customs duty or not), delivery point, payment term and a price. One or more offers to sell a product are received from a seller. The offer to sell comprises the following terms: Product Name, grade, product specifications, origin, producer, quantity, delivery point, delivery period, payment term, invited parties, limitations for buyer counters, and a price. If the price of any particular offer to sell is higher than the price specified by the marketmaker for that particular offer, the offer is rejected and cannot be posted on the Exchange. In response to the offer to sell, one or more counter offers to buy from one or more buyers for the product are received. Preferably, the price of any counter offer to buy from one or more buyers is rejected by the system if the buyer's price is lower than the price specified by the seller under “limitations for buyer counters”. The limitation could be set so that the seller may be open to counter offers within 1, 2 or 3 percent of his/her original posted price. At least one of the counter offers is accepted by the seller.

A computerized method for exchanging products or services is provided. A first entity, for example, a marketmaker specifies one or more terms for a product. The terms comprise a product name, grade, quantity range, product's origin (whether it is subject to customs duty or not), delivery point, payment term and price. One or more offers to sell a product are received from a seller. The offer to sell comprises of the following terms: Product Name, grade, product specifications, origin, producer, quantity, delivery point, delivery period, payment term, invited parties, limitations for buyer counters and price. If the price of any particular offer to sell is higher than the price specified by the marketmaker for that particular offer, the offer is rejected and cannot be posted on the Exchange. In response to the offer to sell, one or more counter offers to buy from one or more buyers for the product are received. Preferably, the price of any counter offer to buy from one or more buyers is rejected by the system if the buyer's price is lower than the price specified by the seller under “limitations for buyer counters”. The limitation can be set so that the seller may be open to counter offers within 1, 2 or 3 percent of his/her original posted price. At least one of the counter offers to buy is received, from the seller, by the system.

A computerized method for exchanging products or services is provided. A first entity, for example, referred to as marketmaker, specifies one or more terms for a product. The terms comprise product name, grade, quantity range, product's origin (whether it is subject to customs duty or not), delivery point, payment term and a price. One or more offers to sell a product are received from a seller. The offer to sell comprises of the following terms: Product Name, grade, product specifications, origin, producer, quantity, delivery point, delivery period, payment term, invited parties, limitations for buyer counters and price. If the price of any particular sell offer is higher than the price specified by the marketmaker for that particular offer, the offer is rejected and cannot be posted on the Exchange. In response to the offer to sell, one or more counter offers to buy from one or more buyers for the product are received. Preferably, the price of any counter offer to buy from one or more buyers is rejected by the system if the buyer's price is lower than the price specified by the seller under “limitations for buyer counters”. The limitation can be set so that the seller may be open to counter offers within 1, 2 or 3 percent of his/her original posted price. An acceptance of at least one of the counter offers to buy or a revised offer to sell are received from the seller. At least one acceptance of the revised offer to sell, or a revised counter offer to buy are received from the buyer. The steps of rejecting and accepting are repeated until the exchange closes with the revised offer to sell now the offer to sell and the revised offer to buy now the offer to buy.

### BRIEF DESCRIPTION OF THE DRAWINGS

FIG. 1 shows a flow chart detailing the present invention

FIG. 2 shows a detailed flow chart for an embodiment according to the present invention.

FIG. 3 shows a marketmaker screen.

### DETAILED DESCRIPTION OF THE PREFERRED EMBODIMENTS

In an embodiment according to the present invention, a trading platform, designed as an exchange, is provided. The trading process is divided into a 1st session and a 2nd session by the trading platform. A marketmaker is used to regulate the prices.

During the 1 st session the marketmaker enters his or her prices during a first period. Sellers (e.g., suppliers) then post offers during a second period. The Exchange Opens (e.g., accepting an offer, or making a counter offer are allowed) and Postings can be viewed during a third period. An “As Is” Buy and Counter/Change Counter Period occur during a fourth period. A Negotiation Phase starts at a fifth period. The Negotiation Phase ends and Exchange Closes at a sixth period.

During the 2nd session the marketmaker revises his or her prices during a seventh period. Sellers post offers during an eighth period. The Exchange Opens and Postings can be viewed again at a ninth period. An “As Is” Buy and Counter/Change Counter Period occur during a tenth period. A Negotiation Phase starts at an eleventh period. The Negotiation Phase ends and Exchange Closes at a twelfth period.

Preferably, each of the above periods except the first period can start after the preceding period has ended or at a preset time after the preceding period has ended.

During the negotiation phase there is no direct competition among the interested parties (e.g., buyers and sellers) to make the best offer and to conclude a deal. The company which posts an offer deals with the interested parties on a one to one basis. When the Exchange opens, the interested party can immediately close a deal by clicking on the “Buy” button or may make a counter offer using a “Counter” or “Negotiate” buttons to negotiate the price on a one to one basis. Preferably, there is no interaction between interested parties and they are not aware of one another. Preferably, all identities are kept anonymous during the transaction.

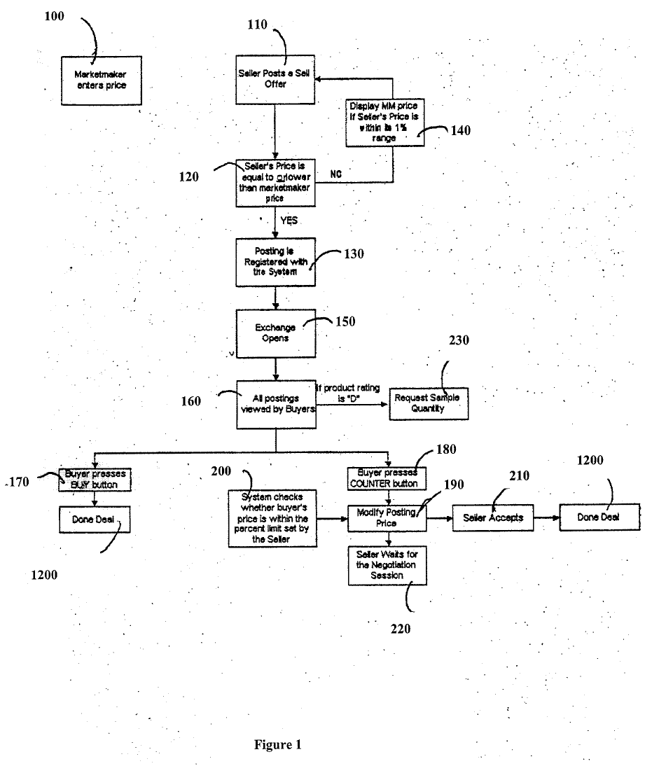

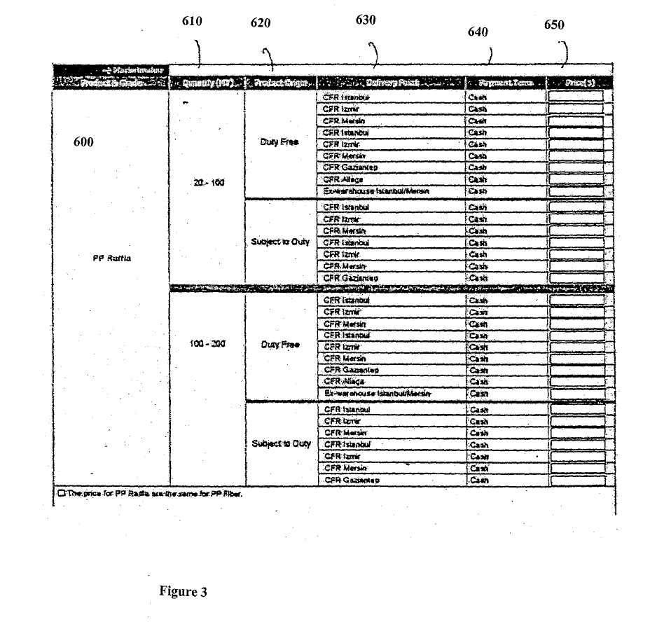

FIG. 1 shows a flow chart detailing the present invention. A marketmaker enters a price for a product (e.g., a plastic product) (Step 100). An exemplary screen that allows the marketmaker to enter the information pertaining to one or more products is shown in FIG. 3. Preferably, the marketmaker enters the price on a daily basis until a certain time, such as 10:00 A.M., is reached. In certain embodiments of the present invention, the marketmaker enters a maximum price for each of the potential offers that might be posted on the system. By doing so, abuse of the system by the sellers can be curtailed and prices that the seller posts can be ensured as close to the current market price for that day.

A seller posts an offer to sell (Step 110). Preferably, the seller posts the offer after the marketmaker has entered the price, for example, after 10:00 am. The seller can choose from terms specified by the system to form a posting. For example, when “Post an Offer” button is clicked, a page with the following information can be viewed and/or entered: Product (e.g., plastics products, such as PP, PVC, LDPE, HDPE and PS), Grade (e.g., Raffia and Fiber for PP; K 65/67 and K 70 for PVC; F212 or G035 for LDPE; Film or Pipe for HDPE; and GPPS or HIPS for PS), Product Specifications, Product Origin, Producer, Quantity (e.g., a quantity range between 20 to 200 MT), Delivery Point (e.g., CFR Istanbul/Izmir/Mersin, CPT Istanbul/lzmir/Gaziantep, FCA Aliaga or ex-warehouse Istanbul/Mersin), Delivery Period (e.g., 1 week, 2 weeks or 1 month), Payment Terms (e.g., types of payment terms), Price, Posting Available to, and Limitation for Buyer Counter Prices.

The producer is included so that the system can match that producer with the product ratings of the buyers. The system can then display to the buyers the producers rating for the product in question which is to be sold. An exemplary method for doing so is detailed below. Product origin information is used by the system to inform the buyers whether or not the product to be sold is subject to customs duty or not. Preferably, the name of the producer and product origin is disclosed when a buyer concludes a deal. The Posting Available can be a selection of buyers selected by the seller. If the posting is available to the selected buyers, then the selected buyers can view the posting, buy the product or counter the seller's offer. The Limitation for Buyer Counter Prices enables the seller to set a minimum price for buyers to meet before entering into negotiation with him/her. The limitation can be set so that the seller may be available to buyer counters within 1, 2 or 3 percent of his/her original posted price.

Once the seller fills in all of these fields he or she can submit the offer by clicking a “Send” button. A confirmation page can then be displayed to the seller. The seller may edit this page by using the “Edit” button, cancel the offer by using the “Cancel” button, or confirm the offer by using the “Confirm” button. When the seller clicks on “Confirm”, the posting is given an ID number and registered with the system. The posting can then be viewed under a “My Postings of the Day” screen (described below). The posting can also viewed under an “Offers To Sell” section at a particular time with any other registered postings.

While submitting an offer, a comparison is made to determine if the price the seller entered is equal to or lower than the price the marketmaker entered (Step 120). If so, the price of the seller is registered in the system (Step 130). The price remains valid on the system for a period of time, such as 1 day, and offers can be posted again after the period of time has elapsed. Preferably, the identity of the sellers and buyers will remain anonymous. In certain embodiments of the present invention, all the offers posted on the exchange are “Firm” (e.g., the seller can not relinquish his or her offer once a buyer has accepted the offer and vice versa.)

If the price the seller entered is not equal to the price the marketmaker entered, the system informs the seller that the price is higher than the marketmaker's price. The seller can then continue to enter prices until the seller's new price is within 1% of the marketmaker's price, at which point the price the seller entered is displayed (Step 140). The method then proceeds to Step 130 using the price the seller entered as the price of the posting.

At a preset time (e.g., period), for example, 11:00-11:30, the exchange opens (Step 150). After the exchange opens, the postings (e.g., offers) by the seller can be viewed by one or more buyers (Step 160). Preferably, both buyers and sellers view all the postings under an “Offers To Sell” page. The “Offers To Sell” page shows a Posting #, Seller's Rating, Product & Grade, Product Rating, Quantity, Delivery Point, Delivery Period, Payment Term and Price, and whether the posting is subject to a duty. Preferably, there are “Buy” and “Counter” buttons next to each offer.

Also, after the exchange opens, the sellers can view the following items for each posting on an “Offers To Sell” page Posting #, Product & Grade, Product Origin, Quantity, Delivery Point, Delivery Period, Payment Term and Price. Preferably, the system has a list of countries which are subject to duty or duty free and by using this information, displays “Duty Free” or “Subject To Duty” in a Product Origin column of “Offers To Sell” for the sellers.

Sellers can track their particular postings from a “My Postings of the Day” page. The “My Postings of the Day” page comprises a Posting #, Product & Grade, Product Info (includes the producer and product origin), Quantity, Delivery Point, Delivery Period, Payment Term, Price, and Status field. At the bottom of the page there is a “Post an Offer” button which can be viewed and used at a particular time, such as 10:00-11:00 and 12:00-13:00, to post offers. Under the Status column, the seller can view a posted, Counter (e.g., the number of counters are stated in parenthesis), Negotiation (e.g, the number of buyer counters are stated in parenthesis) or Sample Request information window. The Seller can click on the posting number of a posting and view the details of the counters or a sample request.

Next to each posting on “Offers To Sell”, there is a “BUY” button and “COUNTER” button. The buttons are available at specific times, for example, between 11:00-11:30, and 14:00-14:30.

Any buyer who would like to accept an “as is” posting (e.g., does not wish to negotiate the price with the seller) can press the “BUY” button (Step 170). Once the “BUY” button is pressed, the buyer views “Accept an Offer” confirmation page with all relevant offer information. The buyer can choose not to accept the offer by using a “Back” button. The buyer can choose to confirm the “offer” by clicking on the “Confirm” button.

Once the buyer clicks “Confirm” the system moves to the “Done Deal” phase (Step 1200). During Step 1200, the buyer is informed of the seller's identity and the contact info as well as the contract terms. The buyer may also print all of this information. Once a deal is concluded, the buyer can also view the offer posting under “My Done Deals” with the seller's identity and product information disclosed. The Seller will be informed on his screen and by e-mail that a buyer has accepted his offer and that a deal is concluded. The Seller sees a “Done Deal” link in the “Status” column under “My Previous Postings”. Once this link is clicked, the seller can view the buyer's identity and contact info. In certain embodiments of the present invention, during Step 1200 the seller may re-post the same offer by clicking on the “Re-post” button next to his offer under “My Previous Postings”.

Once a deal is concluded (Step 1200), the posting in question can be viewed by the seller (e.g., supplier) under a “My Previous Postings” screen. The information for each posting comprises a Posting #, Product & Grade, Product Info (which includes the producer and product origin), Quantity, Delivery Point, Delivery Period, Payment Term, Price, whether it is subject to duty or not, and Status fields. There is a “Re-post” option that allows the seller to make the same posting at a later date. Under a Status column, the seller can view a Done Deal (e.g., the number of concluded deals is stated in parenthesis), Not concluded or Sample Ordered field (e.g, the number of samples ordered is stated in parenthesis). The Seller may also view the contact information of the buyer(s) and the contract information by clicking on the “Done Deal” or “Sample Ordered” links.

The buyers can view their previously concluded deals under a “My Done Deals” post. The information for each previously concluded deal is displayed and comprises Posting #, Seller, Product & Grade, Product Info, Quantity, Delivery Point, Delivery Period, Payment Term, Concluded Price, and whether the concluded deal was subject to duty. Preferably, the buyer can view the contact information of the seller by clicking on a link with the name of the seller.

A buyer could also select a counter option, for example, by pressing the “COUNTER” button (Step 180). Once the “COUNTER” button is pressed, the buyer can view all the relevant offer information and can change the price field (Step 190). When the buyer enters a price and clicks the “Send” button, if his price is lower than the limits set by the seller, he will be informed that his counter price is too low for the seller to consider and that he needs to re-try (Step 200). The buyer can repeat steps 190-200 until the price is accepted by the system.

Once the price is accepted by the system, the buyer will view a confirmation page, he may edit by using the “Edit” button, cancel by using “Cancel” button or confirm by clicking on the “Confirm” button. When the buyer confirms, the seller views the status of this offer under “My Postings of the Day” with a Counter (1) link. Once this link is clicked, he views the details of the buyer's counter offer; the change in price is highlighted in red with the seller's price displayed separately. The Seller may accept this offer, for example, by clicking the “Accept” button (Step 210), in which case a deal is concluded (Step 1200).

The seller may decide not to accept the buyer's counter right away, but wait until the Negotiation Phase (Step 220) to make a new offer to the buyer's counter during the Negotiation Phase. The negotiation phase can start at one or more particular times. For example, the negotiation sessions could start at 11:30 for the first session and 14:30 for the second session. Preferably, the buyer's offer is valid until the end of the Negotiation Session. The buyer may follow the status of his counter to the prior posting from an “Offers In Negotiation” screen.

During the negotiation session (Step 220), the seller can make changes on the sample request. For example, he can change the sample quantity amount, latest delivery time or he can charge the buyer for the sample by entering a price per metric ton for the sample and pressing “Send” button. The buyer will see under status that his request is being replied to. By clicking on the posting number the buyer may view the details of the seller's reply. Changes made by the seller are highlighted with red. The buyer can keep track of his previous communication with the seller by using the links present on the right which includes “My Sample Request”, “Seller's 1st Offer”, so on and so forth. The buyer may either accept or counter the seller's reply. This process can continue until parties reach an agreement or until the exchange closes.

In certain embodiments of the present invention, a buyer may ask for a sample if the product rating of a product to be sold is “D”. If a “D” rating is present, a button is displayed showing that a sample can be sent. If an offer specifies that a sample can be sent, the buyer may elect to have the sample sent, for example, by pressing the button (Step 230). The buyer can then view the “Sample Ordering” page in which he can specify the sample quantity amount and the latest delivery time. This may include, but is not limited to: no deadline, latest within 2 weeks, latest within 1 month or latest within 2 months. Once the buyer fills in this information and sends it to the seller, he can view the information in a posting under “Offers in Negotiation” with a “Sample Requested” status. The seller also views a “Sample Request” link under Status column of his “My Postings of the Day.” When the seller clicks on the link, he views a page where he or she can reply to the buyer's request. If the seller agrees with the quantity amount and latest delivery time and if he will not charge a fee for the sample, the seller may accept the request by clicking on the “Accept” button. Then the seller will view the contact information of the buyer and the terms of the contract. The buyer is also informed that a sample is being ordered via e-mail and on his screen. He can view this posting under “My Done Deals” with a status of “Sample Ordered”.

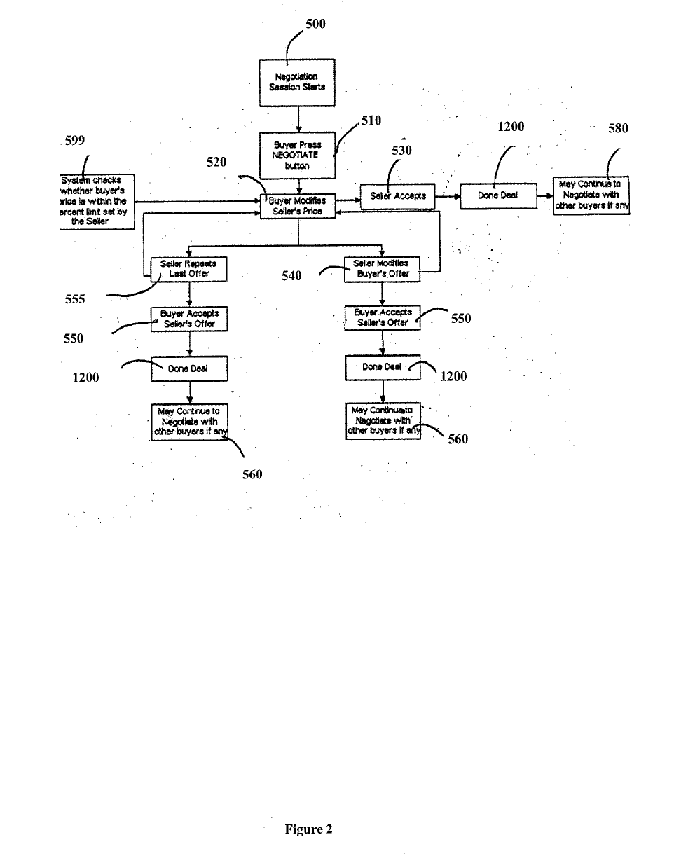

FIG. 2 shows a more detailed flow chart of the negotiation process. Once the negotiation starts (Step 500), the “Buy” and “Counter” buttons next to each posting under an “Offers To Sell” screen are replaced with a “Negotiate” button at the start of negotiation session on the buyer's display. The buyer initiates the negotiation with the seller by clicking on the “NEGOTIATE” button next to each posting on the “Offers To Sell” screen (Step 510). Buyer may negotiate with more than one seller simultaneously. Since all counter offers are “firm”, the system warns the buyer when he tries to negotiate with more than one seller for the same product and grade. The seller may initiate negotiation if there were counter offers made by buyers prior to the start of the Negotiation Session when he decided to wait until the start of the negotiation session to reply to buyer counters of the buyer(s).

As soon as the negotiation button is clicked (Step 510), a page where the buyer can place a counter offer is displayed. The buyer can view all relevant information about the posting, and may change the Price field. The Seller's Original Price is also shown on the right of the page. The buyer enters his price and clicks “Send” button (Step 520). Then the buyer's posting is listed under “Offers In Negotiation” with a “My 1^{st} Counter” written under Status. The seller can view the same posting under his “My Postings of the Day” with “Negotiation (1)” written under a status column. If there are more counter offers sent to the seller during Negotiation session, the number in parenthesis will reflect the number of counter offers. The seller can view the buyer counter offers by clicking on the “Negotiation (1)” status link (e.g., an HTML link).

Once this link is clicked, the seller views a “Negotiation Status Summary” page. The page includes all the information about the posting and a table which includes the following information Buyer ID (e.g., a code referencing an anonymous buyer), Buyer's Rating by the Seller, Buyer's Last Price, My Last Price and Status Information. Status information may include one or more counter offers by the buyer and one or more offers, such as Buyer's 1st Counter, My 1st Offer, Buyer's 2nd Counter, My 2nd Offer. There is a “Reply” button next to each of the buyer counters. By clicking on the “Reply” button next to each counter, the seller may reply to the buyers' offers.

When the seller clicks “Reply”, he views a page where all relevant information about the offer is provided. All of the communication with the buyer regarding the buyer's counters and his replies are shown separately for easy monitoring. The seller may accept buyer's counter, for example, by using the “Accept” button (Step 530), may counter the buyer's counter by using a “Change Price” button (Step 540), or he may repeat his last offer by using a “Repeat Last Offer” button (Step 550).

If the seller elects to accept the offer (Step 540), then a deal is concluded (Step 1200). At this point, the Seller is informed of the identity of the buyer with his contact information and contract terms. The status of this posting is changed to “Done Deal” and it is viewed under “My Previous Postings.” The system asks the seller if he wants to continue negotiating with other buyers. If he accepts, then the seller's posting will continue to be viewed under “Offers to Sell”, but will also be listed under “My Previous Postings” with a “Done Deal” link under “Status (Step 560). The Buyer whose counter is accepted by the seller is informed by e-mail and on his screen that his offer is accepted by the seller. The buyer can view the posting in question under “My Done Deals” with a “Done Deal” status link.

If the seller elects to modify the buyer's price, he clicks on a button (e.g. a change price button) (Step 540), the seller views all relevant information about the posting, and may change the Price field. The seller can also view communication with the buyer regarding the buyer's counters and his own replies separately for easy monitoring. The Seller then makes changes in the price field and clicks the “Send” button to confirm.

The buyer follows the posting subject to negotiation from “Offers In Negotiation” and is informed about the status of his counter through “Status”. The “Seller's Last Price” section will reflect the new price sent by the seller. By clicking on the link of the Posting Number, the buyer may send his next counter offer to the seller (Step 520). The buyer may also accept the seller's offer (Step 550), or repeat his last offer. If the buyer accepts the offer (Step 550), the negotiation is concluded (Step 1200). Otherwise, the method returns to Step 520. Once the negotiation is concluded the seller may continue to negotiate with other buyers (Step 560).

The seller can also elect to repeat the last offer (Step 555). If so, Steps 550, 1200, and 560 are followed as described above. However, the seller does not change the price, instead it remains as it was prior.

Preferably, buyers and sellers may send as many offers/replies (e.g., counter offers) as they like during the negotiation session. Also, a check can be performed by the system to ensure that any prices offered by the buyer remain within a limit set by the seller (Step 599).

In certain embodiments of the present invention, a product rating page is provided. The product rating page allows a buyer to evaluate a particular product. The product rating page is used to make it easier for buyers to conclude a deal about a product without knowing whose product it is. All producers for all the products and grades on the exchange are registered on the system, so that the products can be rated. Preferably, the rating is on a scale of A to E. A refers to “The best product for me.” B refers to “I can use it without much hesitation.” C refers to “I will use it only if I have to.” D refers to “I didn't hear about this product and didn't try and/or use it,” and E refers to “I will never buy this product.”

The Product rating Page consists of a “Making Changes in the Ratings” section and a “Rating New Products” section. The buyer chooses first the product and related grade to be rated under “Rating New Products” section. Once he makes his selection, the “Producer Names” section will be filled with the names of the producers and also their product codes (if available) related to this product and grade. Then the buyer chooses and rates the names he likes by using the arrows for each letter. After finishing rating, he needs to click the “Send” so that this rating is registered with the system. Rated products are viewed with a link under “Making Changes in the Ratings”. This way the buyer can easily make changes to his already existing ratings. When the offers are posted, the system checks the name of the producer identified for that posting with the rated producers of the buyer. The system then displays the letter that the buyer has assigned for that producer under “Product Rating.” The letter could be different for each buyer, since every buyer rates the producers according to their own experience. The letter may also be different for the same producers' different products or grades.

FIG. 3 shows a marketmaker screen. The marketmaker screen allows the marketmaker to enter his daily price for each product and grade for all possible posting options. The marketmaker screen can be used to implement Step 100 of FIG. 1. A product and grade field 600, a quantity field 610, a product origin field 620, a delivery point filed 630, a payment term field 640, and a price field 650 are present. The product and grade field 600 specifies the particular product. The quantity field 610 specifies a quantity range for the requested item. The product origin field 620 specifies whether or not the product is subject to a duty. The delivery point 630 specifies where the product is to be delivered. The payment term 640 specifies the type of payment, for example, cash. The price field 650 specifies the marketrnaker's price for the product. Preferably, the marketmaker can enter the price. A Date field, which can be automatically set by the system, may also be present. The marketmaker screen is displayed in Step 100, for example, when the marketmaker selects the product and grade from a combo box, for example, on a separate page.

The marketmaker can enter the prices for each term for “Cash” payment. The system adjusts the price for all other possible payment terms by a “Payment Terms Conversion Table” where a formula for each payment terms in terms of a “Cash” payment is defined to the system. For example, a credit payment term could multiply the term entered for “Cash” by a fixed amount. In such a manner, prices for all postings for other payment terms are automatically calculated by the system. A similar conversion table exists for shipment terms where relationship between terms may be defined by entering the freight difference or by a formula so that the system calculates the price for some terms automatically (e.g., inco terms).

In the preceding specification, the invention has been described with reference to specific exemplary embodiments thereof. It will, however, be evident that various modifications and changes may be made thereto without departing from the broader spirit and scope of the invention as set forth in the claims that follow. The specification and drawings are accordingly to be regarded in an illustrative manner rather than a restrictive sense.

What is claimed is:

1. A computerized method for exchanging products or services, comprising the steps of:
specifying, by a marketmaker, one or more terms for a product, the terms comprising product name, grade, quantity range, product's origin, delivery point, payment term and a price;
receiving one or more offers to sell the product, from a seller, the offer to sell comprising a product name, grade, product specifications, origin, producer, quantity, delivery point, delivery period, payment term, invited parties, limitations for buyer counters and price;
if the price of any particular sell offer is higher than the price specified by the marketmaker for that particular offer, rejecting the particular offer;
in response to at least one offers to sell, receiving one or more counter offers to buy from one or more buyers for the product; and
accepting, by the seller, at least one of the counter offers to buy.

2. A computerized method for exchanging products or services, comprising the steps of:
specifying, by a marketmaker, one or more terms for a product, the terms comprising product name, grade, quantity range, product's origin, delivery point, payment term and a price;
receiving one or more offers to sell the product, from a seller, the offer to sell comprising a product name, grade, product specifications, origin, producer, quantity, delivery point, delivery period, payment term, invited parties, limitations for buyer counters and price;
if the price of any particular sell offer is higher than the price specified by the marketmaker for that particular offer, rejecting the particular offer;
in response to at least one offers to sell, receiving one or more counter offers to buy from one or more buyers for the product;
if the price for a particular counter offer to buy is lower than the price specified by the seller under a limitations for buyer counters, rejecting the particular counter offer to buy; and
receiving, from the seller, at least one of the counter offers to buy.

3. A computerized method for exchanging products or services, comprising the steps of:
(A) specifying, by a marketmaker, one or more terms for a product, the terms comprising product name, grade, quantity range, origin of the product, delivery point, payment term and a price;
(B) receiving one or more offers to sell the product, from a seller, the offer to sell comprising a product name, grade, product specifications, origin, producer, quantity, delivery point, delivery period, payment term, invited parties, limitations for buyer counters and a price;
(C) if the price of any particular sell offer is higher than the price specified by the marketmaker for that particular offer, rejecting the particular offer;
(D) in response to at least one offers to sell, receiving one or more counter offers to buy from one or more buyers for the product;
(E) if the price for a particular counter offer to buy is lower than the price specified by the seller under the limitations for buyer counters, rejecting the particular counter offer to buy;
(F) accepting, from the seller, at least one acceptance of the counter offer to buy or a revised offer to sell;
(G) accepting, from the buyer, at least one acceptance of the revised offer to sell, or a revised counter offer to buy;
(H) repeating steps E, F, and G with the revised offer to sell replacing the offer to sell and the revised counter offer to buy replacing the counter offer to buy.

4. A computerized method for auctioning products or services, comprising the steps of:
specifying, by a first entity, one or more terms for a product, the terms comprising a price and a payment term;
receiving one or more offers to sell the product, from a seller, the offer to sell comprising the terms;
if the price and payment terms of any particular offer of the one or more offers to sell are more costly than the price and payment terms specified by the first entity, rejecting the particular offer;
in response to at least one offers to sell, receiving one or more offers to buy from one or more buyers for the product;
accepting, by the seller, at least one of the offers to buy.

5. A computerized method for auctioning products or services, comprising the steps of:
specifying, by a first entity, one or more terms for a product, the terms comprising a price and a payment term;
receiving one or more offers to sell the product, from a seller, the offer to sell comprising the terms;
if the price and payment terms of any particular offer of the one or more offers to sell are more costly than the price and payment terms specified by the first entity, rejecting the particular offer;
in response to at least one of the offers to sell, receiving one or more offers to buy from one or more buyers for the product;
receiving, from the seller, at least one of the offers to buy.

6. A computerized method for auctioning products or services, comprising the steps of:
specifying, by a first entity, one or more terms for a product, the terms comprising a price and a payment term;
receiving one or more offers to sell the product, from a seller, the offer to sell comprising the terms;
if the price and payment terms of any particular offer of the one or more offers to sell are more costly than the price and payment terms specified by the first entity, rejecting the particular offer;
receiving one or more offers to buy from one or more buyers for the product;
accepting, from the seller, at least one acceptance of the offer to buy or a revised offer to sell;
accepting, from the buyer, at least one acceptance of the revised offer to sell, or a revised offer to buy;
repeating the steps of rejecting and accepting with the revised offer to sell replacing the offer to sell and the revised offer to buy replacing the offer to buy.

7. The method as recited in claim 4 wherein the seller is a supplier.

8. The method as recited in claim 5 wherein the seller is a supplier.

9. The method as recited in claim 6 wherein the seller is a supplier.

10. The method as recited in claim 4 further comprising the step of assigning a rating to the buyer.

11. The method as recited in claim 5 further comprising the step of assigning a rating to the buyer.

12. The method as recited in claim 6 further comprising the step of assigning a rating to the buyer.

13. The method as recited in claim 4 further comprising the step of assigning an rating to the seller.

14. The method as recited in claim 5 further comprising the step of assigning an rating to the seller.

15. The method as recited in claim 6 further comprising the step of assigning an rating to the seller.

16. The method as recited in claim 4 wherein the first entity is a marketmaker.

17. The method as recited in claim 5 wherein the first entity is a marketmaker.

18. The method as recited in claim 6 wherein the first entity is a marketmaker.

19. The method as recited in claim 4 wherein the step of specifying is done with a marketmaker screen.

20. The method as recited in claim 5 wherein the step of specifying is done with a marketmaker screen.

21. The method as recited in claim 6 wherein the step of specifying is done with a marketmaker screen.
